(19) United States
(12) Patent Application Publication
(10) Pub. No.: US 2021/0316742 A1
(43) Pub. Date: Oct. 14, 2021

(54) ERROR HANDLING IN AN AUTONOMOUS VEHICLE

(71) Applicant: GHOST LOCOMOTION INC., Mountain View, CA (US)

(72) Inventors: JOHN HAYES, MOUNTAIN VIEW, CA (US); VOLKMAR UHLIG, CUPERTINO, CA (US); AARON CARROLL, MOUNTAIN VIEW, CA (US); RICHARD A. SWETZ, LOS ALTOS, CA (US); NIMA SOLTANI, LOS GATOS, CA (US); TIMOTHY CEREXHE, MOUNTAIN VIEW, CA (US)

(21) Appl. No.: 16/843,453

(22) Filed: Apr. 8, 2020

(51) Int. Cl. B60W 50/035; G05B 19/042; B60W 60/00; B60W 50/02

(52) U.S. Cl. CPC B60W 50/035; G05B 19/0428; G05B 2219/24024; B60W 50/0205; G05B 2219/2637; B60W 60/001

(57) ABSTRACT

Error handling in an autonomous vehicle, including: receiving, by a control system of the autonomous vehicle, from an automation computing system, a remediation sequence comprising a first plurality of operational commands determined to bring the autonomous vehicle to a stop; determining, by the control system, that the error state associated with the autonomous vehicle has been reached; and executing, by the control system, in response to the error state being reached, the first plurality of operational commands.

### BACKGROUND

### Field of the Invention

The field of the invention is autonomous vehicle operation, or, more specifically, methods, apparatus, autonomous vehicles, and products for error handling in an autonomous vehicle.

### Description of Related Art

Autonomous vehicle control systems receive and execute driving decisions determined by automation computing systems. In the event of a failure of the automation computing systems, the autonomous vehicle control systems lack the sensor data and decision making capabilities required to generate driving decisions.

### SUMMARY

Error handling in an autonomous vehicle may include: receiving, by a control system of the autonomous vehicle, from an automation computing system, a remediation sequence comprising a first plurality of operational commands determined to bring the autonomous vehicle to a stop; determining, by the control system, that the error state associated with the autonomous vehicle has been reached; and executing, by the control system, in response to the error state being reached, the first plurality of operational commands.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 shows example views of an autonomous vehicle for error handling in an autonomous vehicle.

FIG. 2 is block diagram of an autonomous computing system for error handling in an autonomous vehicle.

FIG. 3 is a block diagram of a redundant power fabric for error handling in an autonomous vehicle.

FIG. 4 is a block diagram of a redundant data fabric for error handling in an autonomous vehicle.

FIG. 5 is an example view of process allocation across CPU packages for error handling in an autonomous vehicle.

FIG. 6 is an example view of an execution environment for error handling in an autonomous vehicle.

FIG. 7 is a flowchart of an example method for error handling in an autonomous vehicle.

FIG. 8 is a flowchart of an example method for error handling in an autonomous vehicle.

FIG. 9 is a flowchart of an example method for error handling in an autonomous vehicle.

FIG. 10 is a flowchart of an example method for error handling in an autonomous vehicle.

FIG. 11 is a flowchart of an example method for error handling in an autonomous vehicle.

### DETAILED DESCRIPTION

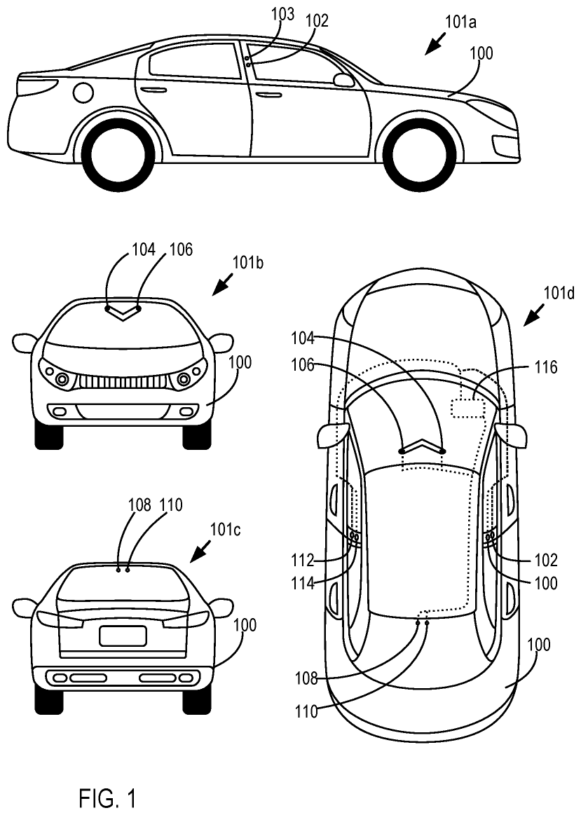

Error handling in an autonomous vehicle may be implemented in an autonomous vehicle. Accordingly, FIG. 1 shows multiple views of an autonomous vehicle 100 configured for error handling in an autonomous vehicle according to embodiments of the present invention. Right side view 101a shows a right side of the autonomous vehicle 100. Shown in the right side view 101a are cameras 102 and 103, configured to capture image data, video data, and/or audio data of the environmental state of the autonomous vehicle 100 from the perspective of the right side of the car. Front view 101b shows a front side of the autonomous vehicle 100. Shown in the front view 101b are cameras 104 and 106, configured to capture image data, video data, and/or audio data of the environmental state of the autonomous vehicle 100 from the perspective of the front of the car. Rear view 101c shows a rear side of the autonomous vehicle 100. Shown in the rear view 101c are cameras 108 and 110, configured to capture image data, video data, and/or audio data of the environmental state of the autonomous vehicle 100 from the perspective of the rear of the car. Top view 101d shows a rear side of the autonomous vehicle 100. Shown in the top view 101d are cameras 102-110. Also shown are cameras 112 and 114, configured to capture image data, video data, and/or audio data of the environmental state of the autonomous vehicle 100 from the perspective of the left side of the car.

Further shown in the top view 101d is an automation computing system 116. The automation computing system 116 comprises one or more computing devices configured to control one or more autonomous operations (e.g., autonomous driving operations) of the autonomous vehicle 100. For example, the automation computing system 116 may be configured to process sensor data (e.g., data from the cameras 102-114 and potentially other sensors), operational data (e.g., a speed, acceleration, gear, orientation, turning direction), and other data to determine a operational state and/or operational history of the autonomous vehicle. The automation computing system 116 may then determine one or more operational commands for the autonomous vehicle (e.g., a change in speed or acceleration, a change in brake application, a change in gear, a change in turning or orientation, etc.). The automation computing system 116 may also capture and store sensor data. Operational data of the autonomous vehicle may also be stored in association with corresponding sensor data, thereby indicating the operational data of the autonomous vehicle 100 at the time the sensor data was captured.

Although the autonomous vehicle 100 if FIG. 1 is shown as car, it is understood that autonomous vehicles 100 configured for error handling in an autonomous vehicle may also include other vehicles, including motorcycles, planes, helicopters, unmanned aerial vehicles (UAVs, e.g., drones), or other vehicles as can be appreciated. Moreover, it is understood that additional cameras or other external sensors may also be included in the autonomous vehicle 100.

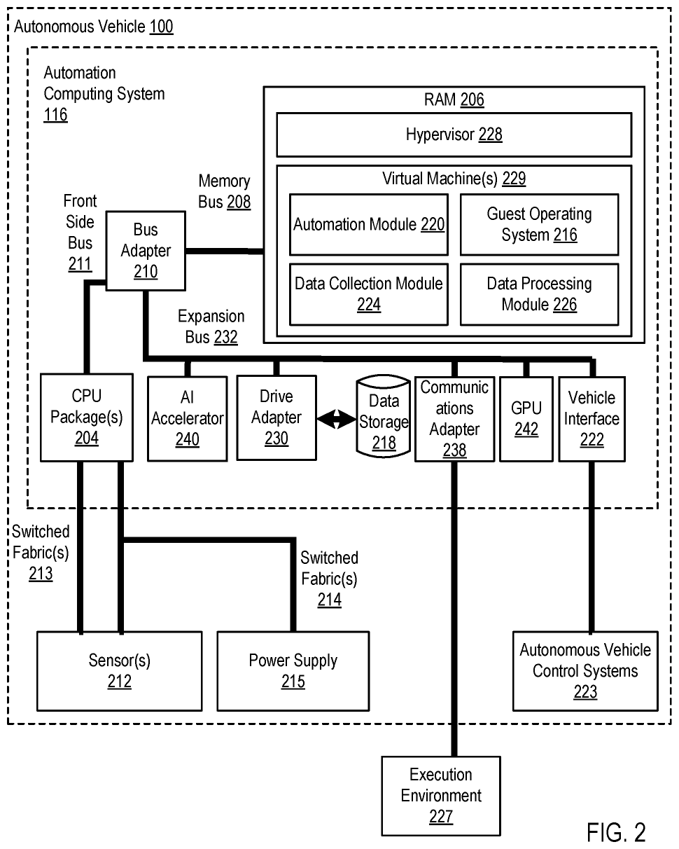

Error handling in an autonomous vehicle in accordance with the present invention is generally implemented with computers, that is, with automated computing machinery. For further explanation, therefore, FIG. 2 sets forth a block diagram of automated computing machinery comprising an exemplary automation computing system 116 configured for error handling in an autonomous vehicle according to embodiments of the present invention. The automation computing system 116 of FIG. 2 includes at least one computer Central Processing Unit (CPU) package 204 as well as random access memory 206 (‘RAM’) which is connected through a high speed memory bus 208 and bus adapter 210 to CPU packages 204 via a front side bus 211 and to other components of the automation computing system 116.

A CPU package 204 may comprise a plurality of processing units. For example, each CPU package 204 may comprise a logical or physical grouping of a plurality of processing units. Each processing unit may be allocated a particular process for execution. Moreover, each CPU package 204 may comprise one or more redundant processing units. A redundant processing unit is a processing unit not allocated a particular process for execution unless a failure occurs in another processing unit. For example, when a given processing unit allocated a particular process fails, a redundant processing unit may be selected and allocated the given process. A process may be allocated to a plurality of processing units within the same CPU package 204 or different CPU packages 204. For example, a given process may be allocated to a primary processing unit in a CPU package 204. The results or output of the given process may be output from the primary processing unit to a receiving process or service. The given process may also be executed in parallel on a secondary processing unit. The secondary processing unit may be included within the same CPU package 204 or a different CPU package 204. The secondary processing unit may not provide its output or results of the process until the primary processing unit fails. The receiving process or service will then receive data from the secondary processing unit. A redundant processing unit may then be selected and have allocated the given process to ensure that two or more processing units are allocated the given process for redundancy and increased reliability.

The CPU packages 204 are communicatively coupled to one or more sensors 212. The sensors 212 are configured to capture sensor data describing the operational and environmental conditions of an autonomous vehicle. For example, the sensors 212 may include cameras (e.g., the cameras 102-114 of FIG. 1), accelerometers, Global Positioning System (GPS) radios, Lidar sensors, or other sensors as can be appreciated. As described herein, cameras may include a stolid state sensor 212 with a solid state shutter capable of measuring photons or a time of flight of photons. For example, a camera may be configured to capture or measure photons captured via the shutter for encoding as images and/or video data. As another example, a camera may emit photons and measure the time of flight of the emitted photons. Cameras may also include event cameras configured to measure changes in light and/or motion of light.

Although the sensors 212 are shown as being external to the automation computing system 116, it is understood that one or more of the sensors 212 may reside as a component of the automation computing system 212 (e.g., on the same board, within the same housing or chassis). The sensors 212 may be communicatively coupled with the CPU packages 204 via a switched fabric 213. The switched fabric 213 comprises a communications topology through which the CPU packages 204 and sensors 212 are coupled via a plurality of switching mechanisms (e.g., latches, switches, crossbar switches, field programmable gate arrays (FPGAs), etc.). For example, the switched fabric 213 may implement a mesh connection connecting the CPU packages 204 and sensors 212 as endpoints, with the switching mechanisms serving as intermediary nodes of the mesh connection. The CPU packages 204 and sensors 212 may be in communication via a plurality of switched fabrics 213. For example, each of the switched fabrics 213 may include the CPU packages 204 and sensors 212, or a subset of the CPU packages 204 and sensors 212, as endpoints. Each switched fabric 213 may also comprise a respective plurality of switching components. The switching components of a given switched fabric 213 may be independent (e.g., not connected) of the switching components of other switched fabrics 213 such that only switched fabric 213 endpoints (e.g., the CPU packages 204 and sensors 212) are overlapping across the switched fabrics 213. This provides redundancy such that, should a connection between a CPU package 204 and sensor 212 fail in one switched fabric 213, the CPU package 204 and sensor 212 may remain connected via another switched fabric 213. Moreover, in the event of a failure in a CPU package 204, a processor of a CPU package 204, or a sensor, a communications path excluding the failed component and including a functional redundant component may be established.

The CPU packages 204 and sensors 212 are configured to receive power from one or more power supplies 215. The power supplies 215 may comprise an extension of a power system of the autonomous vehicle 100 or an independent power source (e.g., a battery). The power supplies 215 may supply power to the CPU packages 204 and sensors 212 by another switched fabric 214. The switched fabric 214 provides redundant power pathways such that, in the event of a failure in a power connection, a new power connection pathway may be established to the CPU packages 204 and sensors 214.

Stored in RAM 206 is an automation module 220. The automation module 220 may be configured to process sensor data from the sensors 212 to determine a driving decision for the autonomous vehicle. The driving decision comprises one or more operational commands for an autonomous vehicle 100 to affect the movement, direction, or other function of the autonomous vehicle 100, thereby facilitating autonomous driving or operation of the vehicle. Such operational commands may include a change in the speed of the autonomous vehicle 100, a change in steering direction, a change in gear, or other command as can be appreciated. For example, the automation module 220 may provide sensor data and/or processed sensor data as one or more inputs to a trained machine learning model (e.g., a trained neural network) to determine the one or more operational commands. The operational commands may then be communicated to autonomous vehicle control systems 223 via a vehicle interface 222.

In some embodiments, the automation module 220 may be configured to determine a remediation sequence for an autonomous vehicle 100 in motion. The remediation sequence includes a sequence of one or more driving decisions that, if executed, are determined and/or predicted to bring the autonomous vehicle 100 to a predefined or preselected operational state. For example, bringing the autonomous vehicle 100 to the predefined operational state may include bringing the autonomous vehicle 100 safely to a stop (e.g., without collision with an object, without violating one or more safety rules). As another example, bringing the autonomous vehicle 100 to a predefined operational state may include moving the autonomous vehicle 100 to a shoulder, left- or rightmost lane, or other portion of a road or path. As a further example, bringing the autonomous vehicle 100 to a predefined operational state may include reducing the speed of the autonomous vehicle 100 to a reduced predefined or dynamically calculated speed. The automation module 220 may determine a both a driving decision and a remediation sequence at a predefined interval. The automation module 220 may then send the driving decision and the remediation sequence to the autonomous vehicle control systems 223. The autonomous vehicle control systems 223 may be configured to execute the driving decision unless an error state has been reached. If an error decision has been reached, therefore indicating a possible error in functionality of the automation computing system 116), the autonomous vehicle control systems 224 may then execute a last received remediation sequence in order to bring the autonomous vehicle 100 to the predefined operational state. Thus, the autonomous vehicle control systems 223 are configured to receive both a driving decision and remediation sequence at predefined intervals, and execute the remediation sequence in response to an error.

The autonomous vehicle control systems 223 are configured to affect the movement and operation of the autonomous vehicle 100. For example, the autonomous vehicle control systems 223 may activate (e.g., apply one or more control signals) to actuators or other components to turn or otherwise change the direction of the autonomous vehicle 100, accelerate or decelerate the autonomous vehicle 100, change a gear of the autonomous vehicle 100, or otherwise affect the movement and operation of the autonomous vehicle 100.

Further stored in RAM 206 is a data collection module 224 configured to process and/or store sensor data received from the one or more sensors 212. For example, the data collection module 224 may store the sensor data as captured by the one or more sensors 212, or processed sensor data 212 (e.g., sensor data 212 having object recognition, compression, depth filtering, or other processes applied). Such processing may be performed by the data collection module 224 in real-time or in substantially real-time as the sensor data is captured by the one or more sensors 212. The processed sensor data may then be used by other functions or modules. For example, the automation module 220 may use processed sensor data as input to determining one or more operational commands. The data collection module 224 may store the sensor data in data storage 218.

Also stored in RAM 206 is a data processing module 226. The data processing module 226 is configured to perform one or more processes on stored sensor data (e.g., stored in data storage 218 by the data collection module 218) prior to upload to a execution environment 227. Such operations can include filtering, compression, encoding, decoding, or other operations as can be appreciated. The data processing module 226 may then communicate the processed and stored sensor data to the execution environment 227.

Further stored in RAM 206 is a hypervisor 228. The hypervisor 228 is configured to manage the configuration and execution of one or more virtual machines 229. For example, each virtual machine 229 may emulate and/or simulate the operation of a computer. Accordingly, each virtual machine 229 may comprise a guest operating system 216 for the simulated computer. The hypervisor 228 may manage the creation of a virtual machine 229 including installation of the guest operating system 216. The hypervisor 228 may also manage when execution of a virtual machine 229 begins, is suspended, is resumed, or is terminated. The hypervisor 228 may also control access to computational resources (e.g., processing resources, memory resources, device resources) by each of the virtual machines.

Each of the virtual machines 229 may be configured to execute one or more of the automation module 220, the data collection module 224, the data processing module 226, or combinations thereof. Moreover, as is set forth above, each of the virtual machines 229 may comprise its own guest operating system 216. Guest operating systems 216 useful in autonomous vehicles in accordance with some embodiments of the present disclosure include UNIX™, Linux™, Microsoft Windows™, AIX™, IBM's i OS™, and others as will occur to those of skill in the art. For example, the autonomous vehicle 100 may be configured to execute a first operating system when the autonomous vehicle is in an autonomous (or even partially autonomous) driving mode and the autonomous vehicle 100 may be configured to execute a second operating system when the autonomous vehicle is not in an autonomous (or even partially autonomous) driving mode. In such an example, the first operating system may be formally verified, secure, and operate in real-time such that data collected from the sensors 212 are processed within a predetermined period of time, and autonomous driving operations are performed within a predetermined period of time, such that data is processed and acted upon essentially in real-time. Continuing with this example, the second operating system may not be formally verified, may be less secure, and may not operate in real-time as the tasks that are carried out (which are described in greater detail below) by the second operating system are not as time-sensitive the tasks (e.g., carrying out self-driving operations) performed by the first operating system.

Readers will appreciate that although the example included in the preceding paragraph relates to an embodiment where the autonomous vehicle 100 may be configured to execute a first operating system when the autonomous vehicle is in an autonomous (or even partially autonomous) driving mode and the autonomous vehicle 100 may be configured to execute a second operating system when the autonomous vehicle is not in an autonomous (or even partially autonomous) driving mode, other embodiments are within the scope of the present disclosure. For example, in another embodiment one CPU (or other appropriate entity such as a chip, CPU core, and so on) may be executing the first operating system and a second CPU (or other appropriate entity) may be executing the second operating system, where switching between these two modalities is accomplished through fabric switching, as described in greater detail below. Likewise, in some embodiments, processing resources such as a CPU may be partitioned where a first partition supports the execution of the first operating system and a second partition supports the execution of the second operating system.

The guest operating systems 216 may correspond to a particular operating system modality. An operating system modality is a set of parameters or constraints which a given operating system satisfies, and are not satisfied by operating systems of another modality. For example, a given operating system may be considered a “real-time operating system” in that one or more processes executed by the operating system must be performed according to one or more time constraints. For example, as the automation module 220 must make determinations as to operational commands to facilitate autonomous operation of a vehicle. Accordingly, the automation module 220 must make such determinations within one or more time constraints in order for autonomous operation to be performed in real time. The automation module 220 may then be executed in an operating system (e.g., a guest operating system 216 of a virtual machine 229) corresponding to a “real-time operating system” modality. Conversely, the data processing module 226 may be able to perform its processing of sensor data independent of any time constrains, and may then be executed in an operating system (e.g., a guest operating system 216 of a virtual machine 229) corresponding to a “non-real-time operating system” modality.

As another example, an operating system (e.g., a guest operating system 216 of a virtual machine 229) may comprise a formally verified operating system. A formally verified operating system is an operating system for which the correctness of each function and operation has been verified with respect to a formal specification according to formal proofs. A formally verified operating system and an unverified operating system (e.g., one that has not been formally verified according to these proofs) can be said to operate in different modalities.

The automation module 220, data collection module 224, data collection module 224, data processing module 226, hypervisor 228, and virtual machine 229 in the example of FIG. 2 are shown in RAM 206, but many components of such software typically are stored in non-volatile memory also, such as, for example, on data storage 218, such as a disk drive. Moreover, any of the automation module 220, data collection module 224, and data processing module 226 may be executed in a virtual machine 229 and facilitated by a guest operating system 216 of that virtual machine 229.

The automation computing system 116 of FIG. 2 includes disk drive adapter 230 coupled through expansion bus 232 and bus adapter 210 to processor(s) 204 and other components of the automation computing system 116. Disk drive adapter 230 connects non-volatile data storage to the automation computing system 116 in the form of data storage 213. Disk drive adapters 230 useful in computers configured for error handling in an autonomous vehicle according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The exemplary automation computing system 116 of FIG. 2 includes a communications adapter 238 for data communications with other computers and for data communications with a data communications network. Such data communications may be carried out serially through RS-238 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for error handling in an autonomous vehicle according to embodiments of the present invention include modems for wired dial-up communications, Ethernet (IEEE 802.3) adapters for wired data communications, 802.11 adapters for wireless data communications, as well as mobile adapters (e.g., cellular communications adapters) for mobile data communications. For example, the automation computing system 116 may communicate with one or more remotely disposed execution environments 227 via the communications adapter 238.

The exemplary automation computing system of FIG. 2 also includes one or more Artificial Intelligence (AI) accelerators 240. The AI accelerator 240 provides hardware-based assistance and acceleration of AI-related functions, including machine learning, computer vision, etc. Accordingly, performance of any of the automation module 220, data collection module 224, data processing module 226, or other operations of the automation computing system 116 may be performed at least in part by the AI accelerators 240.

The exemplary automation computing system of FIG. 2 also includes one or more graphics processing units (GPUs) 242. The GPUs 242 are configured to provide additional processing and memory resources for processing image and/or video data, including encoding, decoding, etc. Accordingly, performance of any of the automation module 220, data collection module 224, data processing module 226, or other operations of the automation computing system 116 may be performed at least in part by the GPUs 242.

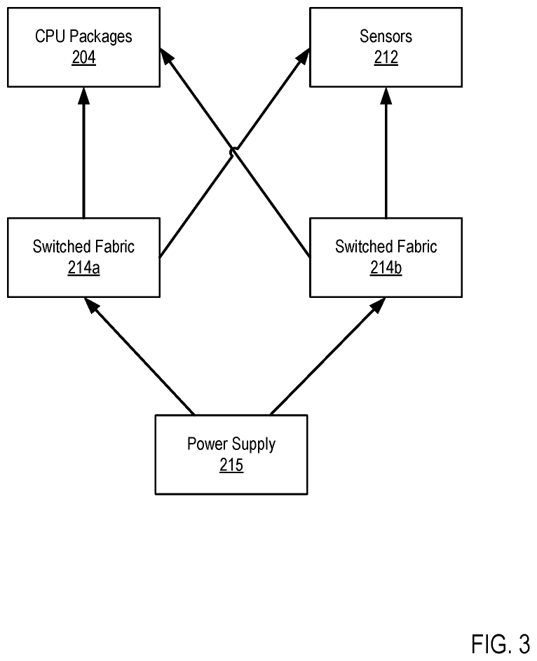

FIG. 3 shows an example redundant power fabric for error handling in an autonomous vehicle. The redundant power fabric provides redundant pathways for power transfer between the power supplies 215, the sensors 212, and the CPU packages 204. In this example, the power supplies 215 are coupled to the sensors 212 and CPU packages via two switched fabrics 214a and 214b. The topology shown in FIG. 3 provides redundant pathways between the power supplies 215, the sensors 212, and the CPU packages 204 such that power can be rerouted through any of multiple pathways in the event of a failure in an active connection pathway. The switched fabrics 214a and 214b may provide power to the sensors 212 using various connections, including Mobile Industry Processor Interface (MIPI), Inter-Integrated Circuit (I2C), Universal Serial Bus (USB), or another connection. The switched fabrics 214a and 214b may also provide power to the CPU packages 204 using various connections, including Peripheral Component Interconnect Express (PCIe), USB, or other connections. Although only two switched fabrics 214a and 214b are shown connecting the power supplies 215 to the sensors 212 and CPU packages 204, it is understood that the approach shown by FIG. 3 can be modified to include additional switched fabrics 214.

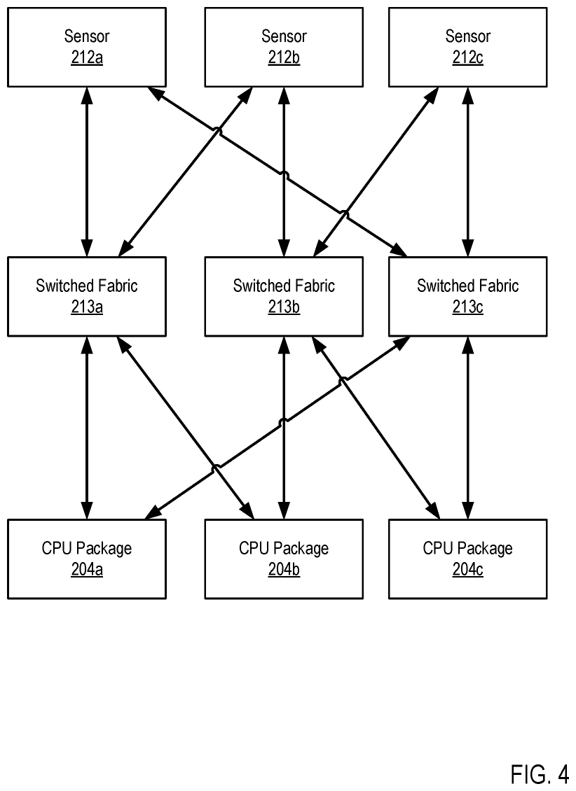

FIG. 4 is an example redundant data fabric for error handling in an autonomous vehicle. The redundant data fabric provides redundant data connection pathways between sensors 212 and CPU packages 204. In this example view, three CPU packages 204a, 204b, and 204c are connected to three sensors 212a, 212b, and 212c via three switched fabrics 213a, 213b, and 213c. Each CPU package 204a, 204b, and 204c is connected to a subset of the switched fabrics 213a, 213b, and 213c. For example, CPU package 204a is connected to switched fabrics 213a and 213c, CPU package 204b is connected to switched fabrics 213a and 213b, and CPU package 204c is connected to switched fabrics 213b and 213c. Each switched fabric 213a, 213b, and 213c is connected to a subset of the sensors 212a, 212b, and 212c. For example, switched fabric 213a is connected to sensors 212a and 212b, switched fabric 213b is connected to sensor 212b and 212c, and switched fabric 213c is connected to sensors 212a and 212c. Under this topology, each CPU package 204a, 204b, and 204c has an available connection path to any sensor 212a, 212b, and 212c. It is understood that the topology of FIG. 4 is exemplary, and that CPU packages, switched fabrics, sensors, or connections between components may be added or removed while maintaining redundancy as can be appreciated by one skilled in the art.

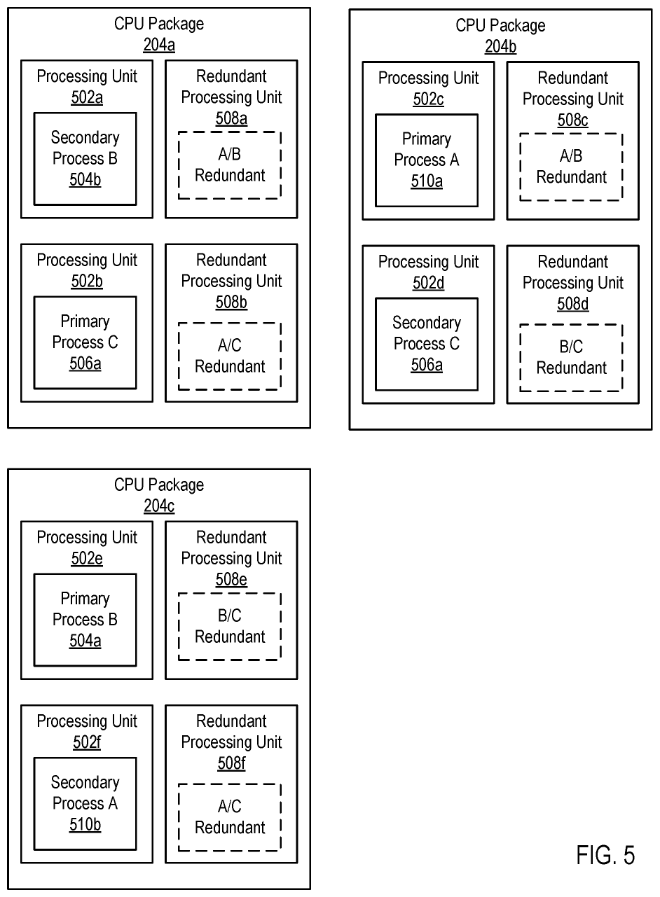

FIG. 5 is an example view of process allocation across CPU packages for error handling in an autonomous vehicle. Shown are three CPU packages 204a, 204b, and 204c. Each CPU package 204a includes a processing unit that has been allocated (e.g., by a hypervisor 228 or other process or service) primary execution of a process and another processing unit that has been allocated secondary execution of a process. As set forth herein, primary execution of a process describes an executing instance of a process whose output will be provided to another process or service. Secondary execution of the process describes executing an instance of the process in parallel to the primary execution, but the output may not be output to the other process or service. For example, in CPU package 204a, processing unit 502a has been allocated secondary execution of “process B,” denoted as secondary process B 504b, while processing unit 502b has been allocated primary execution of “process C,” denoted as primary process C 506a.

CPU package 204a also comprises two redundant processing units that are not actively executing a process A, B, or C, but are instead reserved in case of failure of an active processing unit. Redundant processing unit 508a has been reserved as “AB redundant,” indicating that reserved processing unit 508a may be allocated primary or secondary execution of processes A or B in the event of a failure of a processing unit allocated the primary or secondary execution of these processes. Redundant processing unit 508b has been reserved as “A/C redundant,” indicating that reserved processing unit 508b may be allocated primary or secondary execution of processes A or C in the event of a failure of a processing unit allocated the primary or secondary execution of these processes.

CPU package 204b includes processing unit 502c, which has been allocated primary execution of “process A,” denoted as primary process A 510a, and processing unit 502d, which has been allocated secondary execution of “process C,” denoted as secondary process C 506a. CPU package 204b also includes redundant processing unit 508c, reserved as “AB redundant,” and redundant processing unit 508d, reserved as “B/C redundant.” CPU package 204c includes processing unit 502e, which has been allocated primary execution of “process B,” denoted as primary process B 504a, and processing unit 502f, which has been allocated secondary execution of “process A,” denoted as secondary process A 510a. CPU package 204c also includes redundant processing unit 508e, reserved as “B/C redundant,” and redundant processing unit 508f, reserved as “A/C redundant.”

As set forth in the example view of FIG. 5, primary and secondary instances processes A, B, and C are each executed in an allocated processing unit. Thus, if a processing unit performing primary execution of a given process fails, the processing unit performing secondary execution may instead provide output of the given process to a receiving process or service. Moreover, the primary and secondary execution of a given process are executed on different CPU packages. Thus, if an entire processing unit fails, execution of each of the processes can continue using one or more processing units handling secondary execution. The redundant processing units 508a-f allow for allocation of primary or secondary execution of a process in the event of processing unit failure. This further prevents errors caused by processing unit failure as parallel primary and secondary execution of a process may be restored. One skilled in the art would understand that the number of CPU packages, processing units, redundant processing units, and processes may be modified according to performance requirements while maintaining redundancy.

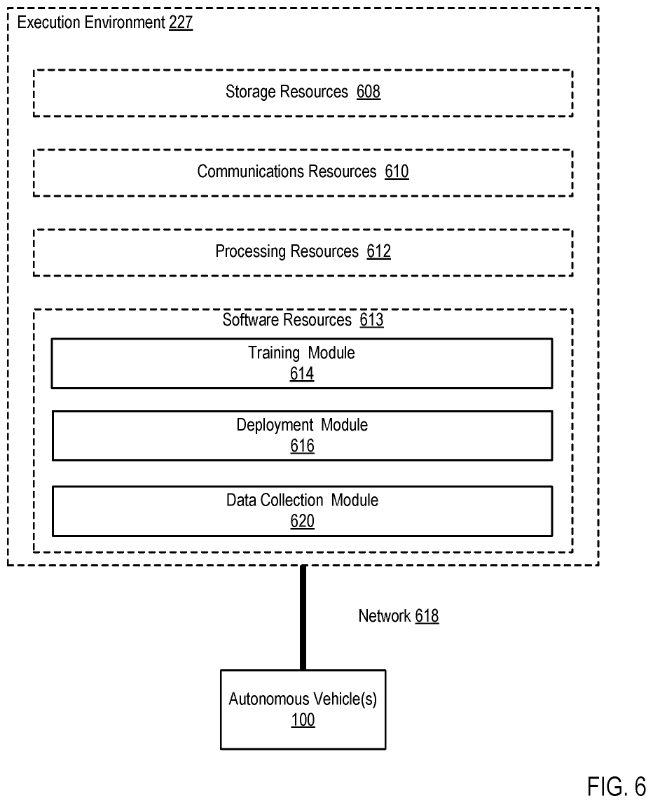

For further explanation, FIG. 6 sets forth a diagram of an execution environment 227 accordance with some embodiments of the present disclosure. The execution environment 227 depicted in FIG. 6 may be embodied in a variety of different ways. The execution environment 227 may be provided, for example, by one or more cloud computing providers such as Amazon AWS, Microsoft Azure, Google Cloud, and others, including combinations thereof. Alternatively, the execution environment 227 may be embodied as a collection of devices (e.g., servers, storage devices, networking devices) and software resources that are included in a private data center. In fact, the execution environment 227 may be embodied as a combination of cloud resources and private resources that collectively form a hybrid cloud computing environment. Readers will appreciate that the execution environment 227 may be constructed in a variety of other ways and may even include resources within one or more autonomous vehicles or resources that communicate with one or more autonomous vehicles.

The execution environment 227 depicted in FIG. 6 may include storage resources 608, which may be embodied in many forms. For example, the storage resources 608 may include flash memory, hard disk drives, nano-RAM, 3D crosspoint non-volatile memory, MRAM, non-volatile phase-change memory (‘PCM’), storage class memory (‘SCM’), or many others, including combinations of the storage technologies described above. Readers will appreciate that other forms of computer memories and storage devices may be utilized as part of the execution environment 227, including DRAM, SRAM, EEPROM, universal memory, and many others. The storage resources 608 may also be embodied, in embodiments where the execution environment 227 includes resources offered by a cloud provider, as cloud storage resources such as Amazon Elastic Block Storage (‘EBS’) block storage, Amazon S3 object storage, Amazon Elastic File System (‘EFS’) file storage, Azure Blob Storage, and many others. The example execution environment 227 depicted in FIG. 6 may implement a variety of storage architectures, such as block storage where data is stored in blocks, and each block essentially acts as an individual hard drive, object storage where data is managed as objects, or file storage in which data is stored in a hierarchical structure. Such data may be saved in files and folders, and presented to both the system storing it and the system retrieving it in the same format.

The execution environment 227 depicted in FIG. 6 also includes communications resources 610 that may be useful in facilitating data communications between components within the execution environment 227, as well as data communications between the execution environment 227 and computing devices that are outside of the execution environment 227. Such communications resources may be embodied, for example, as one or more routers, network switches, communications adapters, and many others, including combinations of such devices. The communications resources 610 may be configured to utilize a variety of different protocols and data communication fabrics to facilitate data communications. For example, the communications resources 610 may utilize Internet Protocol (‘IP’) based technologies, fibre channel (‘FC’) technologies, FC over ethernet (‘FCoE’) technologies, InfiniBand (‘IB’) technologies, NVM Express (‘NVMe’) technologies and NVMe over fabrics (‘NVMeoF’) technologies, and many others. The communications resources 610 may also be embodied, in embodiments where the execution environment 227 includes resources offered by a cloud provider, as networking tools and resources that enable secure connections to the cloud as well as tools and resources (e.g., network interfaces, routing tables, gateways) to configure networking resources in a virtual private cloud. Such communications resources may be useful in facilitating data communications between components within the execution environment 227, as well as data communications between the execution environment 227 and computing devices that are outside of the execution environment 227 (e.g., computing devices that are included within an autonomous vehicle).

The execution environment 227 depicted in FIG. 6 also includes processing resources 612 that may be useful in useful in executing computer program instructions and performing other computational tasks within the execution environment 227. The processing resources 612 may include one or more application-specific integrated circuits (‘ASICs’) that are customized for some particular purpose, one or more central processing units (‘CPUs’), one or more digital signal processors (‘DSPs’), one or more field-programmable gate arrays (‘FPGAs’), one or more systems on a chip (‘SoCs’), or other form of processing resources 612. The processing resources 612 may also be embodied, in embodiments where the execution environment 227 includes resources offered by a cloud provider, as cloud computing resources such as one or more Amazon Elastic Compute Cloud (‘EC2’) instances, event-driven compute resources such as AWS Lambdas, Azure Virtual Machines, or many others.

The execution environment 227 depicted in FIG. 6 also includes software resources 613 that, when executed by processing resources 612 within the execution environment 227, may perform various tasks. The software resources 613 may include, for example, one or more modules of computer program instructions that when executed by processing resources 612 within the execution environment 227 are useful in training neural networks configured to determine control autonomous vehicle control operations. For example, a training module 614 may train a neural network using training data including sensor 212 data and control operations recorded or captured contemporaneous to the training data. In other words, the neural network may be trained to encode a relationship between an environment relative to an autonomous vehicle 100 as indicated in sensor 212 data and the corresponding control operations effected by a user or operation of the autonomous vehicle. The training module 614 may provide a corpus of training data, or a selected subset of training data, to train the neural network. For example, the training module 614 may select particular subsets of training data associated with particular driving conditions, environment states, etc. to train the neural network.

The software resources 613 may include, for example, one or more modules of computer program instructions that when executed by processing resources 612 within the execution environment 227 are useful in deploying software resources or other data to autonomous vehicles 100 via a network 618. For example, a deployment module 616 may provide software updates, neural network updates, or other data to autonomous vehicles 100 to facilitate autonomous vehicle control operations.

The software resources 613 may include, for example, one or more modules of computer program instructions that when executed by processing resources 612 within the execution environment 227 are useful in collecting data from autonomous vehicles 100 via a network 618. For example, a data collection module 620 may receive, from autonomous vehicles 100, collected sensor 212, associated control operations, software performance logs, or other data. Such data may facilitate training of neural networks via the training module 614 or stored using storage resources 608.

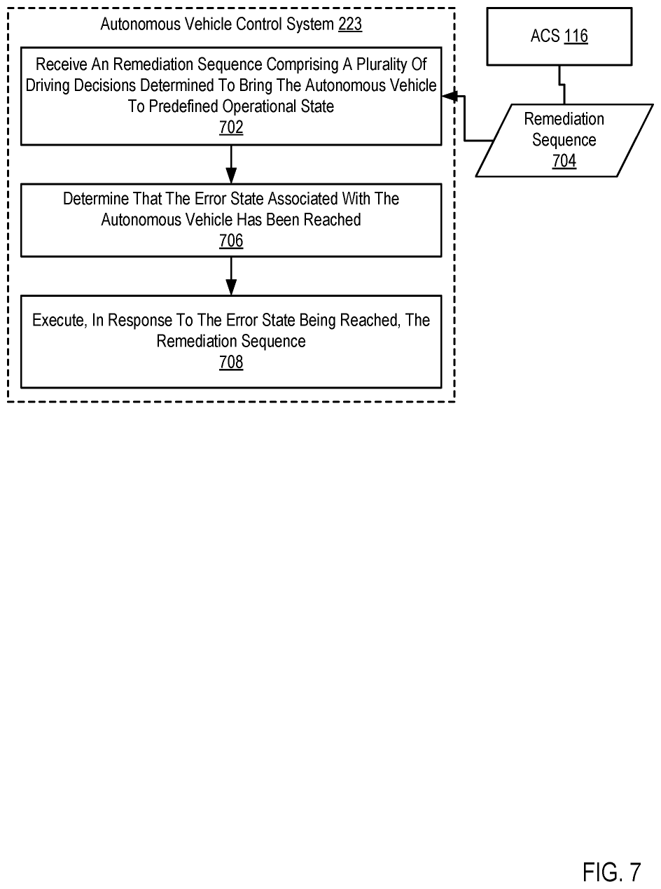

For further explanation, FIG. 7 sets forth a flow chart illustrating an exemplary method for error handling in an autonomous vehicle that includes receiving 702 (e.g., by an autonomous vehicle control system 223 from an automation computing system (ACS) 116) a remediation sequence 704 comprising a plurality of driving decisions determined to bring the autonomous vehicle 100 to a predefined operational state. The autonomous vehicle control system 223 may receive the remediation sequence 704 along with a driving decision from the automation computing system 116. The automation computing system 116 may be configured to determine, at a predefined interval, the driving decision and the remediation sequence. The automation computing system 116 may determine the remediation sequence similar to determining a driving decision. For example, a machine learning model (e.g., of an automation module 220) may accept, as input, sensor data and other data to predict movement locations of objects in the environment relative to the autonomous vehicle 100. The automation module 220 may then predict a first portion of the remediation sequence (e.g., one or more operational commands) to bring the autonomous vehicle 220 to the predefined operational state. The machine learning model may predict the movement and locations of objects based on the autonomous vehicle 220 performing the previously determined operational commands. Thus, the automation module 220 may repeatedly predict operational commands and placements/movements of objects relative to the autonomous vehicle 100 until the entire remediation sequence 704 has been determined. In other words, the driving decision may be determined as a combination of operational commands to be executed within a particular interval or window (e.g., based on the interval or frequency at which the driving decisions are determined), while the remediation sequence 704 may be determined as a series or sequence of driving decisions to be executed in order across multiple intervals.

The predefined operational state of the autonomous vehicle 100 may comprise an operational state to reduce risk of collision, accident, or other hazards in the event that the error state associated with the autonomous vehicle 100 has been reached. For example, the predefined operational state may include stopping the autonomous vehicle 100. Accordingly, bringing the autonomous vehicle 100 to the predefined operational state may include bringing the autonomous vehicle 100 to a stop without collision with another vehicle or object and/or without violating one or more safety rules or laws. Bringing the autonomous vehicle 100 to the predefined operational state may include moving the autonomous vehicle 100 to a shoulder, side of the road, left- or rightmost lane, or other portion of a road or path. Bringing the autonomous vehicle 100 to the predefined operational state may include reducing the speed of the autonomous vehicle 100 to a predefined or dynamically calculated value. Bringing the autonomous vehicle 100 to the predefined operational state may also include combinations of the examples set forth above, or other states. For example, bringing the autonomous vehicle 100 to the predefined operational state may include moving the autonomous vehicle 100 to a shoulder of the road and bringing the autonomous vehicle 100 safely to a complete stop.

The automation computing system 116 may then send both the driving decision and the remediation sequence 704 to the autonomous vehicle control system 223. Thus, both the driving decision and the remediation sequence 704 are based on a current operational state (e.g., speed, direction of movement, etc.) and environmental state (e.g., location of objects, size of objects, movement direction of objects relative to the autonomous vehicle 100, etc.) of the autonomous vehicle 100 when the determination is made by the automation computing system 116.

The method of FIG. 7 also includes determining 706 (e.g., by the autonomous vehicle control system 223) that the error state associated with the autonomous vehicle 100 has been reached. In some embodiments, the error state includes a failure to receive a driving decision and/or updated remediation sequence 704 (e.g., a more recently determined remediation sequence 704 compared to the previously received 702 remediation sequence 704) from the automation computing system 116. For example, assuming that the automation computing system 704 is configured to determine and send driving decisions and remediation sequence 704 at a predefined interval, the error state may include failure to receive the driving decision and remediation sequence 704 according to the predefined interval, or for a number of intervals meeting a threshold. The error state may also include a failure to receive a heartbeat message or other signal at a predefined interval or for a predefined duration. The error state may also include receiving a driving decision including one or more invalid operational commands. For example, one or more operational commands in the driving decision may violate one or more rules (e.g., based on an operational state of the autonomous vehicle 100). The error state may also include receiving data (e.g., a driving decision or remediation sequence 704) that fails one or more data integrity checks (e.g., hashing, cyclic redundancy checks, parity bits, etc.).

The method of FIG. 7 also includes executing 708 (e.g., by the autonomous vehicle control system 223), in response to the error state being reached, the remediation sequence 704. Executing 708 the first plurality of remediation sequence 704 includes sending one or more control signals to actuators or other components of steering, braking and/or acceleration systems of the autonomous vehicle 100 based on the plurality of driving decisions in the remediation sequence 704. Thus, the autonomous vehicle control system 223 executes the remediation sequence 704 in order to safely bring the autonomous vehicle 100 to the predefined operational state in response to the error state being reached.

As the autonomous vehicle control system 223 lacks the sensory input or decision making capabilities of the automation computing system 116, the autonomous vehicle control system 223 cannot intelligently determine driving decisions in the event that the automation computing system 116 experiences an error. Accordingly, the automation computing system 116 provides updated remediation sequences 704 in conjunction with driving decisions. The autonomous vehicle control system 223 may then execute the driving decisions as they are received, and store or otherwise maintain a most recently received remediation sequence 704. The most recently received remediation sequence 704 may then be executed by the autonomous vehicle control system 223 in the event that an error is detected. Thus, the autonomous vehicle control system 223 can bring the autonomous vehicle 100 to the predefined operational state (e.g., a safe stop, moved to the shoulder) in the absence of the external sensor inputs or decision making capabilities required to determine a driving decision.

Executing 708 the remediation sequence 704 may be overridden based on one or more conditions being satisfied. Executing 708 the remediation sequence 704 may be overridden (e.g., halted, interrupted) if the autonomous vehicle 100 exits the error state. For example, if the autonomous vehicle control system 223 receives another driving decision from the automation computing system 116, indicating that communication with the automation computing system 116 has been restored, or if the autonomous vehicle control system 223 receives a valid driving decision, the autonomous vehicle control system 223 may then execute the received driving decision instead of continuing to execute 708 the remediations sequence 704. As a further example, if the autonomous vehicle control system 223 receives a signal or indication that a manual or user-operated driving mode has been engaged, execution 708 of the remediation sequence 704 may be overridden.

Executing 708 the remediation sequence 704 may be delayed for a predefined interval (e.g., a predefined number of seconds) in order to determine if a condition for overriding execution 708 of the remediation sequence 704 has been satisfied. For example, executing 708 the remediation sequence 704 may be delayed for a predefined interval to allow a user to enter a manual driving mode in response to the error state being reached.

The autonomous vehicle 223 may also perform other actions in addition to executing 708 the remediation sequence 704 in response to the error state being reached. For example, hazard lights of the vehicle may be activated. As another example, one or more warning lights, dashboard indicators, or other visual indicators that the error state has been reached may be activated.

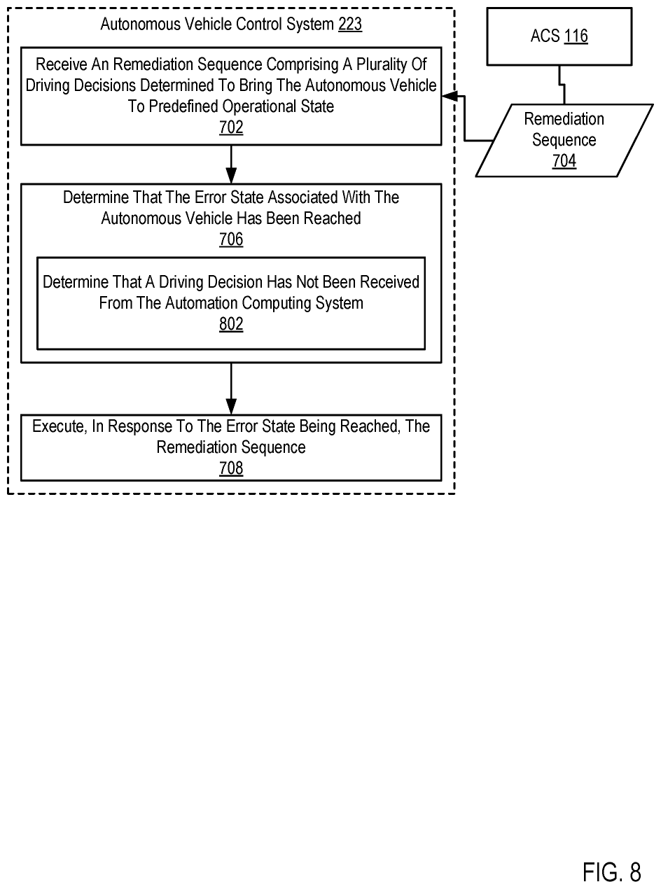

For further explanation, FIG. 8 sets forth a flow chart illustrating an exemplary method for error handling in an autonomous vehicle that includes receiving 702 (e.g., by an autonomous vehicle control system 223 from an automation computing system (ACS) 116) a remediation sequence 704 comprising a plurality of driving decisions determined to bring the autonomous vehicle 100 to a predefined operational state; determining 706 (e.g., by the autonomous vehicle control system 223) that the error state associated with the autonomous vehicle 100 has been reached; and executing 708 (e.g., by the autonomous vehicle control system 223), in response to the error state being reached, the remediation sequence 704.

The method of FIG. 8 differs from FIG. 7 in that determining 706 that the error state associated with the autonomous vehicle 100 has been reached includes determining 802 (e.g., by the autonomous vehicle control system 223) that a driving decision has not been received from the automation computing system 116. Determining 802 that a driving decision has not been received may include determining that the driving decision has not been received within a time window. For example, assuming that the automation computing system 116 is configured to determine and send a driving decision and remediation sequence 704 at a predefined interval, the time window may comprise one or more intervals. Thus, the plurality of driving decisions that are executed 708 by the autonomous vehicle control system 223 correspond to a remediation sequence 704 received with a most recently received driving decision.

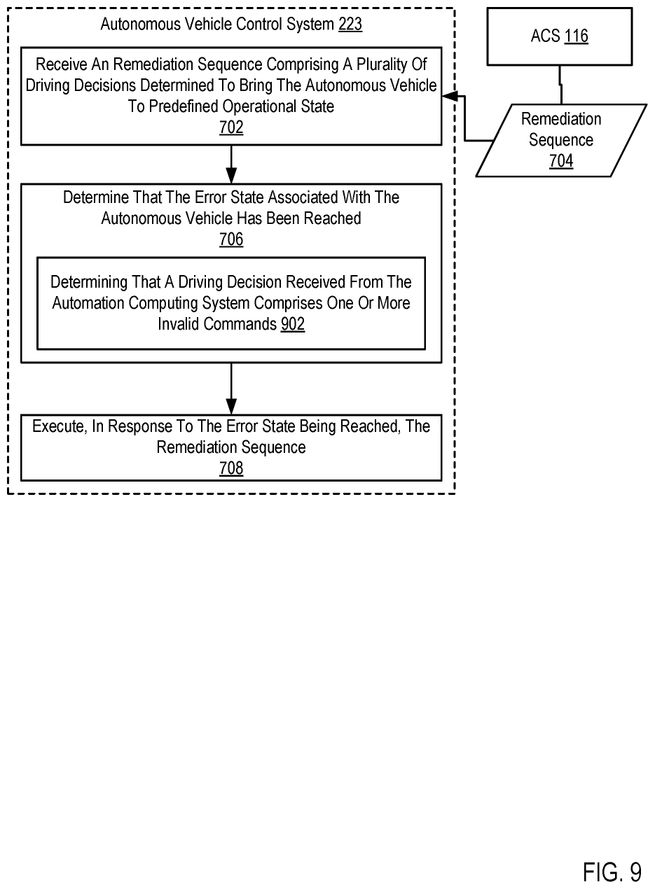

For further explanation, FIG. 9 sets forth a flow chart illustrating an exemplary method for error handling in an autonomous vehicle that includes receiving 702 (e.g., by an autonomous vehicle control system 223 from an automation computing system (ACS) 116) a remediation sequence 704 comprising a plurality of driving decisions determined to bring the autonomous vehicle 100 to a predefined operational state; determining 706 (e.g., by the autonomous vehicle control system 223) that the error state associated with the autonomous vehicle 100 has been reached; and executing 708 (e.g., by the autonomous vehicle control system 223), in response to the error state being reached, the remediation sequence 704.

The method of FIG. 9 differs from FIG. 7 in that determining 706 that the error state associated with the autonomous vehicle 100 has been reached includes determining 902 (e.g., by the autonomous vehicle control system 223) that a driving decision received from the automation computing system 116 comprises one or more invalid commands. For example, the autonomous vehicle control system 223 may maintain a table or data structure of valid operational commands. The table of valid operational commands may indicate, for a given operational state of the autonomous vehicle 100, one or more valid operational commands or one or more constraints for a valid operational command. For example, for an autonomous vehicle 100 traveling at a given speed, the table may indicate a range or threshold for how many degrees a steering wheel may be turned in a given driving decision cycle. As another example, for an autonomous vehicle traveling at a given speed and/or turning at a given radius, the table may indicate an acceptable amount of acceleration or deceleration. Thus, a command in a driving decision is invalid if it is excluded from an enumeration of valid commands and/or violates one or more constraints for a valid command.

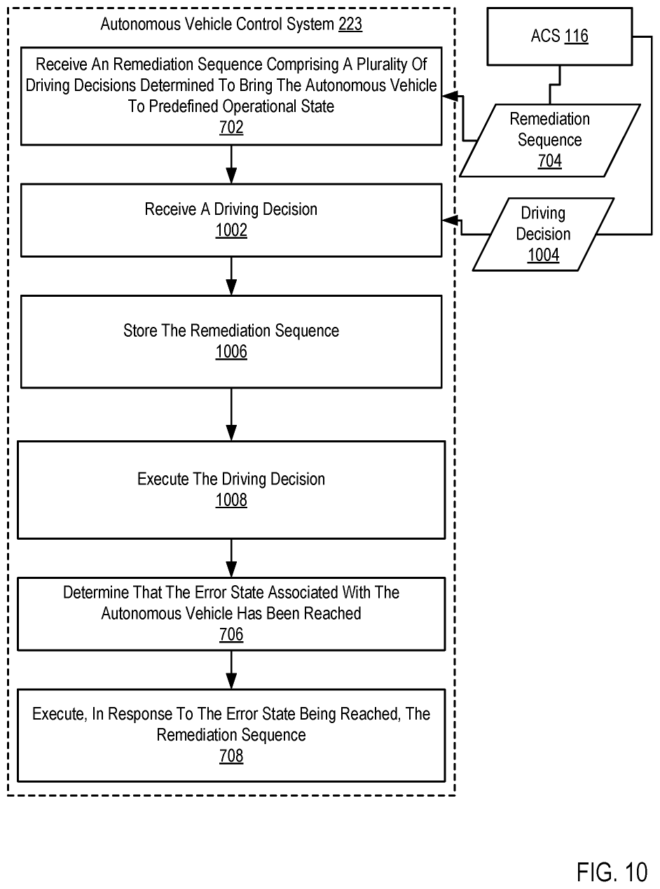

For further explanation, FIG. 10 sets forth a flow chart illustrating an exemplary method for error handling in an autonomous vehicle that includes receiving 702 (e.g., by an autonomous vehicle control system 223 from an automation computing system (ACS) 116) a remediation sequence 704 comprising a plurality of driving decisions determined to bring the autonomous vehicle 100 to a predefined operational state; determining 706 (e.g., by the autonomous vehicle control system 223) that the error state associated with the autonomous vehicle 100 has been reached; and executing 708 (e.g., by the autonomous vehicle control system 223), in response to the error state being reached, the remediation sequence.

The method of FIG. 10 differs from FIG. 7 in that the method of FIG. 10 includes receiving 1002 (e.g., from an automation computing system 116 by the autonomous vehicle control system 223) a driving decision 1004. The driving decision 1004 may be received 1002 contemporaneous to receiving 702 the remediation sequence 704. For example, the automation computing system 116 may be configured to determine and send remediation sequences 704 and driving decisions 1004 at a predefined interval. Thus, the received (702, 1002) remediation sequence 704 and driving decision 1004 may be associated with a same interval.

The method of FIG. 10 also includes storing 1006 the remediation sequence 704. The remediation sequence 704 may be stored in a cache or other memory of the autonomous vehicle control system 223. The remediation sequence 704 in response to determining that one or more error states associated with the autonomous vehicle 100 have not been reached. For example, the remediation sequence 704 may be stored 1006 in response to determining that all operational commands in the driving decision 1004 are valid (e.g., conforming to one or more constraints and/or included in an enumeration of valid commands). Storing 106 the remediation sequence 704 may include overwriting or erasing a previously stored remediation sequence 704. For example, the autonomous vehicle control system 223 may be configured to store a most recently received remediation sequence 704, as the most recently received remediation sequence 704 was determined based on a most recently assessed operational and environmental state of the autonomous vehicle 100. As the remediation sequence 704 is stored 1006, the remediation sequence 704 may be loaded and used at a subsequent (e.g., next) interval or cycle if it is determined that an error state has been reached.

The method of FIG. 10 also includes executing 1008 (e.g., by the autonomous vehicle control system 223) the the driving decision 1004. Executing 1008 the driving decision 1004 includes executing one or more operational commands indicated in the driving decision 1004. The driving decision 1004 may be executed 1008 in response to determining that one or more error states have not been reached. Thus, the autonomous vehicle 100 continues autonomous operation by executing 1008 the driving decision 1004 received from the automation computing system 116, while the remediation sequence 704 is stored 1006 for subsequent use if necessary. For example, at a next interval or cycle, the automated vehicle control system 223 determines 706 that the error state has been reached, and uses the remediation sequence 704 received 702 in the previous interval to bring the autonomous vehicle 100 to the predefined operational state.

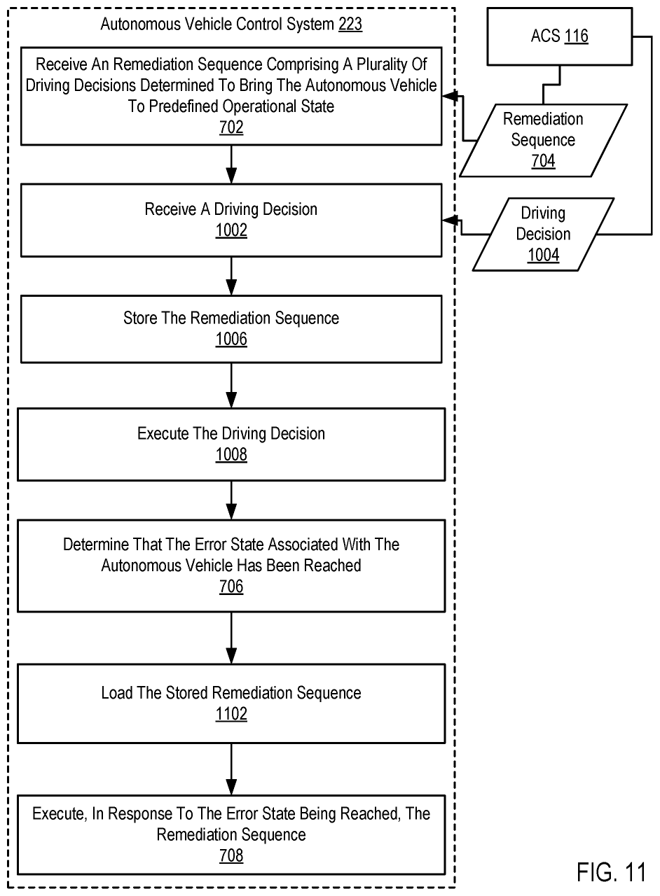

For further explanation, FIG. 11 sets forth a flow chart illustrating an exemplary method for error handling in an autonomous vehicle that includes receiving 702 (e.g., by an autonomous vehicle control system 223 from an automation computing system (ACS) 116) a remediation sequence 704 comprising a plurality of driving decisions determined to bring the autonomous vehicle 100 to a predefined operational state; receiving 1002 (e.g., from an automation computing system 116 by the autonomous vehicle control system 223) a driving decision 1004; storing 1006 the remediation sequence 704; executing 1008 (e.g., by the autonomous vehicle control system 223) the the driving decision 1004; determining 706 (e.g., by the autonomous vehicle control system 223) that the error state associated with the autonomous vehicle 100 has been reached; and executing 708 (e.g., by the autonomous vehicle control system 223), in response to the error state being reached, the remediation sequence 704.

The method of FIG. 11 differs from FIG. 10 in that the method of FIG. 11 includes loading 1102 the stored remediation sequence 704. For example, the remediation sequence 704 stored 1006 in the memory of the automated vehicle control system 223 (e.g., at a previous cycle or interval) may be loaded 1102 in response to determining 706 that the error state has been reached. Thus, a most recently determined and/or received 702 remediation sequence 704 is used to bring the autonomous vehicle 100 to a predefined operational state.

In view of the explanations set forth above, readers will recognize that the benefits of error handling in an autonomous vehicle according to embodiments of the present invention include:
Improved performance of an autonomous vehicle by providing safety measures in the event of a failure in an automation computing system
Improved performance of an autonomous vehicle by allowing an autonomous vehicle control system to bring the autonomous vehicle to a safe operational state despite lacking the sensory data or decision making capabilities required to generate driving decisions (e.g., as found in the automation computing system 116).

Exemplary embodiments of the present invention are described largely in the context of a fully functional computer system for error handling in an autonomous vehicle. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood that any of the functionality or approaches set forth herein may be facilitated at least in part by artificial intelligence applications, including machine learning applications, big data analytics applications, deep learning, and other techniques. Applications of such techniques may include: machine and vehicular object detection, identification and avoidance; visual recognition, classification and tagging; algorithmic financial trading strategy performance management; simultaneous localization and mapping; predictive maintenance of high-value machinery; prevention against cyber security threats, expertise automation; image recognition and classification; question answering; robotics; text analytics (extraction, classification) and text generation and translation; and many others.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for error handling in an autonomous vehicle, comprising:
generating, by an automation computing system of the autonomous vehicle, at a predefined interval, a first driving decision and a sequence of one or more second driving decisions, wherein the sequence of one or more second driving decisions is generated to cause the autonomous vehicle to come to a safe stop;
sending, by the automation computing system, to a control system of the autonomous vehicle, the first driving decision and the sequence of one or more second driving decisions; and
determining, by the control system, whether to execute a last received first driving decision or a last received sequence of one or more second driving decisions based on whether an error state associated with the autonomous vehicle has been reached.

2. (canceled)

3. The method of claim 1, further comprising determining, by the control system, that the error state has been reached by determining that a driving decision has not been received from the automation computing system.

4. The method of claim 1, further comprising determining, by the control system, that the error state has been reached by determining that a received driving decision comprises one or more invalid commands.

5. The method of claim 1, further comprising:
receiving, by the control system, from the automation computing system, the first driving decision and the sequence of one or more second driving decisions;
storing the sequence of one or more second driving decisions; and
executing, responsive to the error state not being reached, the first driving decision.

6. The method of claim 5, further comprising:
loading, responsive to the error state being reached, the stored sequence of one or more second driving decisions; and
executing the loaded sequence of one or more second driving decisions.

7. (canceled)

8. An apparatus for error handling in an autonomous vehicle, the apparatus configured to perform steps comprising:
generating, by an automation computing system of the autonomous vehicle, at a predefined interval, a first driving decision and a sequence of one or more second driving decisions, wherein the sequence of one or more second driving decisions is generated to cause the autonomous vehicle to come to a safe stop;
sending, by the automation computing system, to a control system of the autonomous vehicle, the first driving decision and the sequence of one or more second driving decisions; and
determining, by the control system, whether to execute a last received first driving decision or a last received sequence of one or more second driving decisions based on whether an error state associated with the autonomous vehicle has been reached.

9. (canceled)

10. The apparatus of claim 8, further comprising determining, by the control system, that the error state has been reached by determining that a driving decision has not been received from the automation computing system.

11. The apparatus of claim 8, further comprising determining, by the control system, that the error state has been reached by determining that a received driving decision comprises one or more invalid commands.

12. The apparatus of claim 8, wherein the steps further comprise:
receiving, by the control system, from the automation computing system, the first driving decision and the sequence of one or more second driving decisions;
storing the sequence of one or more second driving decisions; and
executing, responsive to the error state not being reached, the first driving decision.

13. The apparatus of claim 12, wherein the steps further comprise:
loading, responsive to the error state being reached, the stored sequence of one or more second driving decisions; and
executing the loaded sequence of one or more second driving decisions.

14. (canceled)

15. An autonomous vehicle for error handling in an autonomous vehicle, the autonomous vehicle comprising an apparatus configured to perform steps comprising:
generating, by an automation computing system of the autonomous vehicle, at a predefined interval, a first driving decision and a sequence of one or more second driving decisions, wherein the sequence of one or more second driving decisions is generated to cause the autonomous vehicle to come to a safe stop;
sending, by the automation computing system, to a control system of the autonomous vehicle, the first driving decision and the sequence of one or more second driving decisions; and
determining, by the control system, whether to execute a last received first driving decision or a last received sequence of one or more second driving decisions based on whether an error state associated with the autonomous vehicle has been reached.

16. (canceled)

17. The autonomous vehicle of claim 15, further comprising determining, by the control system, that the error state has been reached by determining that a driving decision has not been received from the automation computing system.

18. The autonomous vehicle of claim 15, further comprising determining, by the control system, that the error state has been reached by determining that a received driving decision comprises one or more invalid commands.

19. The autonomous vehicle of claim 15, wherein the steps further comprise:
receiving, by the control system, from the automation computing system, the first driving decision and the sequence of one or more second driving decisions;
storing the sequence of one or more second driving decisions; and
executing, responsive to the error state not being reached, the first driving decision.

20. The autonomous vehicle of claim 19, wherein the steps further comprise:
loading, responsive to the error state being reached, the stored sequence of one or more second driving decisions; and
executing the loaded sequence of one or more second driving decisions.

21. (canceled)

22. A computer program product disposed upon a non-transitory computer readable medium, the computer program product comprising computer program instructions for error handling in an autonomous vehicle that, when executed, cause a computer system of the autonomous vehicle to carry out the steps of:
generating, by an automation computing system of the autonomous vehicle, at a predefined interval, a first driving decision and a sequence of one or more second driving decisions, wherein the sequence of one or more second driving decisions is generated to cause the autonomous vehicle to come to a safe stop;
sending, by the automation computing system, to a control system of the autonomous vehicle, the first driving decision and the sequence of one or more second driving decisions; and
determining, by the control system, whether to execute a last received first driving decision or a last received sequence of one or more second driving decisions based on whether an error state associated with the autonomous vehicle has been reached.
